(19) United States
(12) Patent Application Publication
(10) Pub. No.: US 2018/0201022 A1
(43) Pub. Date: Jul. 19, 2018

(54) ACTUATORS FOR FLUID DELIVERY SYSTEMS

(71) Applicant: FUJIFILM Dimatix, Inc., Lebanon, NH (US)

(72) Inventor: Christoph Menzel, New London, NH (US)

(73) Assignee: FUJIFILM Dimatix, Inc., Lebanon, NH (US)

(21) Appl. No.: 15/849,224

(22) Filed: Dec. 20, 2017

Related U.S. Application Data
(60) Provisional application No. 62/445,978, filed on Jan. 13, 2017.

(51) Int. Cl. B41J 2/175; B41J 2/14; B41J 2/18; B41J 2/045

(52) U.S. Cl. CPC B41J 2/17596; B41J 2/14201; B41J 2/17503; B41J 2/04581; B41J 2/18

(57) ABSTRACT

An apparatus includes a pumping chamber and a descender having a first end and a second end. The first end of the descender is centered relative to the pumping chamber and defines a first fluid flow pathway between the pumping chamber and a nozzle disposed at the second end of the descender. One or more second fluid flow pathways are defined at the second end of the descender.

### CROSS-REFERENCE TO RELATED APPLICATIONS

This application claims the benefit of priority to U.S. Provisional Application Ser. No. 62/445,978, filed on Jan. 13, 2017, the contents of which are hereby incorporated by reference.

### TECHNICAL FIELD

This specification relates to actuators for fluid delivery systems.

### BACKGROUND

Ink jet printing can be performed using an ink jet print head that includes multiple nozzles. The printhead can include a fluid ejector that eject ink through a nozzle. The fluid ejector can define flow pathways to transport the fluid from a reservoir to the nozzle. In some cases, the fluid ejector can define additional flow pathways that transport fluid that is not ejected from the nozzle to recirculation pathway. Fluid that flows through the recirculation pathway can be ejected in a subsequent ejection operation.

### SUMMARY

In one aspect, an apparatus includes a pumping chamber and a descender having a first end and a second end. The first end of the descender is centered relative to the pumping chamber and defines a first fluid flow pathway between the pumping chamber and a nozzle disposed at the second end of the descender. One or more second fluid flow pathways are defined at the second end of the descender.

In another aspect, a system includes a reservoir, a pumping chamber including an inlet to receive fluid from the reservoir, a descender having a first end and a second end. The first end of the descender is centered relative to the pumping chamber and defines a first fluid flow pathway between the pumping chamber and a nozzle disposed at the second end of the descender. One or more second fluid flow pathways are defined at the second end of the descender.

Implementations include one or more of the features described below and herein elsewhere.

In some implementations, the apparatus or the system includes a piezoelectric actuator operable to pump fluid through the pumping chamber toward the nozzle.

In some implementations, the pumping chamber includes a first inlet to receive fluid from a reservoir. In some cases, the pumping chamber includes a second inlet to receive fluid from the reservoir. In some cases, a width of the descender is 10% to 90% a distance between the first inlet and the second inlet. In some cases, the first inlet and the second inlet are equidistant to the first end of the descender. In some cases, the first inlet is configured to be connected to a first reservoir and the second inlet is configured to be connected to a second reservoir.

In some implementations, the pumping chamber is symmetric about a longitudinal axis extending through the first end and the second end of the descender.

In some implementations, the pumping chamber, the descender, and the nozzle are configured such that a resonance frequency in a fluid flow pathway between an inlet of the pumping chamber and an outlet of the pumping chamber is at least 10 kHz to 1 MHz.

In some implementations, the nozzle is configured such that a first portion of fluid flow from the pumping chamber through the descender is ejected through the nozzle, and the one or more second fluid flow pathways are configured to receive a second portion of fluid flow that is not ejected through the nozzle.

In some cases, the one or more second fluid flow pathways includes a plurality of fluid flow pathways to receive a portion of fluid flow from the pumping chamber through the descender. A first of the fluid flow pathways is, for example, to be connected to the first reservoir, and a second of the fluid flow pathways to be connected to the second reservoir. The portion of the fluid flow is, for example, not ejected through the nozzle.

In some implementations, the one or more second fluid flow pathways is a recirculation fluid flow pathway. In some cases, the recirculation fluid flow pathway includes a first end proximate to the second end of the descender and a second end configured to be connected to a reservoir.

Advantages of the foregoing may include, but are not limited to, those described below and herein elsewhere. The configurations of the flow pathways can increase the rate at which fluid can be ejected from the printhead. In particular, a configuration of the flow pathways can increase a resonance frequency of the flow pathways in the printhead, thereby increasing the frequency at which the pumping chamber can be actuated to eject fluid from the printhead. With a higher resonance frequency, the printhead can achieve a higher maximum flow rate. The configuration of the flow pathways further enables the fluid to be ejected even when lower voltages are applied to the actuator driving the pumping chamber.

The details of one or more implementations of the subject matter described in this specification are set forth in the accompanying drawings and the description below. Other potential features, aspects, and advantages will become apparent from the description, the drawings, and the claims.

### BRIEF DESCRIPTION OF THE DRAWINGS

FIG. 1 is a side view of a fluid delivery system.

FIG. 2 is a cross-sectional view of a printhead

FIG. 3 is a cross sectional view of a portion of a printhead.

FIG. 4A is a cross sectional view of a fluid ejector.

FIG. 4B is a cross-sectional view of the fluid ejector of FIG. 4A taken along line 4B-4B in FIG. 4A.

Like reference numbers and designations in the various drawings indicate like elements.

### DETAILED DESCRIPTION

A fluid ejector, e.g., for an ink jet printer, can include flow pathways that enable an actuator to be actuated rapidly, e.g., at a rate between 10 kHz, and 1 MHz, 0 and 250 kHz, 0 and 1 MHz, or higher. In some examples, a descender of the fluid ejector can be positioned so as to decrease a distance that fluid travels from a reservoir to a nozzle of the fluid ejector. In some cases, the fluid ejector includes multiple fluid flow pathways between the reservoir and the nozzle. Compared to fluid ejectors having single fluid flow pathways between the reservoir and the nozzle, the fluid ejector having multiple flow pathways can have relatively lower impedance. The fluid ejector can alternatively or additionally include multiple fluid flow pathways from the fluid ejector to a recirculation system. Such configurations of fluid ejectors and others described herein can enable the actuators associated with the fluid ejectors to be rapidly driven to eject fluid from the fluid ejectors.

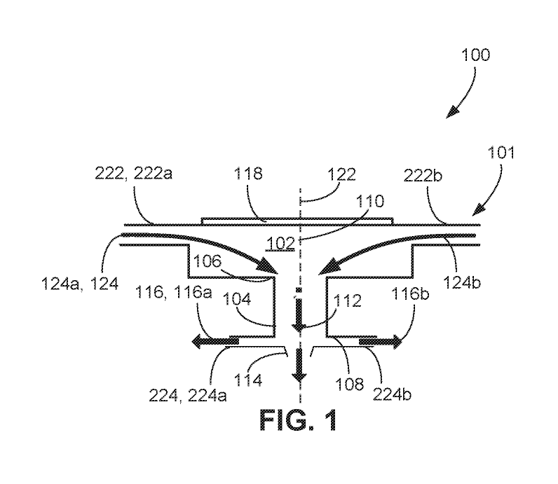

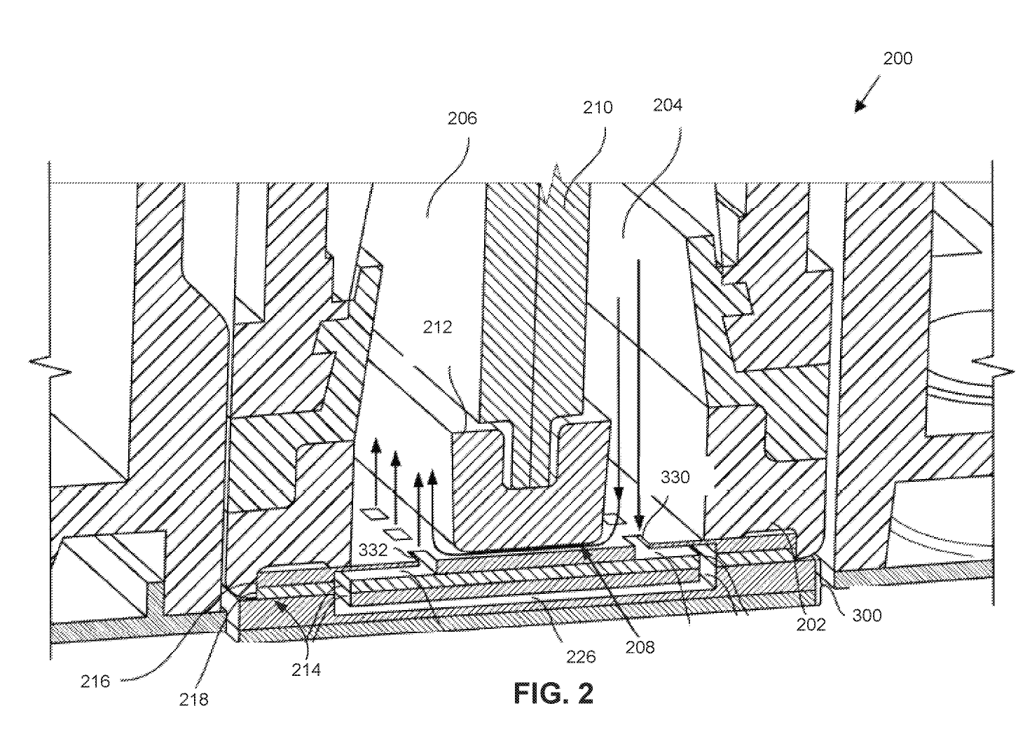

FIG. 1 depicts an example of a fluid delivery system 100 including a fluid ejector 101, e.g., for a printhead 200 shown in FIG. 2, having a configuration of flow pathways that enables more rapid ejection of fluid from a pumping chamber 102 of the fluid ejector 101. The fluid ejector 101 includes flow pathways to transport fluid from a reservoir to a nozzle 114 of the fluid ejector. The fluid ejector 101 includes a descender 104 having a first end 106 and a second end 108. The first end 106 defines a first fluid flow pathway 112 between the pumping chamber 102 and the nozzle 114. The nozzle 114 is disposed at the second end 108 of the descender 104. A second fluid flow pathway 116 is defined at the second end 108 of the descender 104. The second fluid flow pathway 116, for example, corresponds to a recirculation pathway to recirculate fluid in an ejection operation, e.g., a printing operation. The recirculated fluid is, for example, returned to the reservoir and reused for a subsequent ejection operation, e.g., a subsequent printing operation. The fluid ejector 101 includes an actuator 118 operable to pump fluid through the pumping chamber 102 toward the nozzle 114.

The first fluid flow pathway 112, for example, corresponds to a fluid flow pathway for fluid that is pumped out of the pumping chamber 102. If the pumping chamber receives fluid from multiple fluid flow pathways, the first fluid flow pathway 112 receives the fluid from the multiple fluid flow pathways such that a single flow of fluid is directed through the descender 104.

In the example shown in FIG. 1, the descender 104 is centered relative to the pumping chamber 102, e.g., the first end 106 of the descender 104 is centered relative to the pumping chamber 102. In some cases, the pumping chamber 102 receives fluid from multiple fluid flow pathways, and the descender 104 is centered such that the locations at which the fluid flow pathways are connected to the pumping chamber 102 are substantially equally distanced from the descender 104. In some cases, the first fluid flow pathway 112 from the pumping chamber 102 to the descender 104 is centered relative to the pumping chamber 102. Because the descender 104 is centered relative to the pumping chamber 102, a distance between an origin of fluid to be ejected, e.g., a reservoir, and the nozzle 114 is decreased. The decreased distance results in a decreased travel time for a portion of the fluid through the fluid flow pathways. The decreased travel time, in turn, indicates that a resonance frequency of the flow pathway between the reservoir and the nozzle 114 is higher, thereby enabling the fluid ejector 101 to eject fluid more quickly. Additionally or alternatively, in some implementations, multiple flow pathways converge upon entering the fluid ejector 101, e.g., from a supply chamber, and/or multiple flow pathways diverge upon exiting the fluid ejector 101, thereby increasing the resonance frequency of the flow pathway without decreasing an amount of fluid transported through the fluid ejector. In addition, the amount of deflection of the actuator 118 can be maintained and the stiffness of the actuator 118 can be maintained.

The fluid ejector 101, for example, forms a part of the printhead 200 as depicted in FIG. 2. The printhead 200 ejects droplets of fluid, such as ink, biological liquids, polymers, liquids for forming electronic components, or other types of fluid, onto a surface. The printhead 200 includes one or more fluid ejectors 101, each fluid ejector including a corresponding actuator 118, as described with respect to FIG. 1.

Referring to FIGS. 2-4B, the printhead 200 includes a substrate 300 coupled to a deformable membrane 303 of the fluid ejector 101 and to an interposer assembly 214. The substrate 300 is, in some cases, a monolithic semiconductor body, such as a silicon substrate, with passages formed therethrough that define flow pathways for fluid through the substrate 300. In some implementations, the substrate 300 and the membrane 303 together define the pumping chamber 102. The substrate 300, for example, defines the fluid conduits of the fluid ejector 101, e.g., the pumping chamber 102, the descender 104, the nozzle 114, etc.

The printhead 200 includes a casing 202 having an interior volume divided into a fluid supply chamber 204 and a fluid return chamber 206. In some cases, the interior volume is divided by a dividing structure 208. The dividing structure 208 includes, for example, an upper divider 210 and a lower divider 212. The bottom of the fluid supply chamber 204 and the fluid return chamber 206 is defined by the top surface of the interposer assembly 214.

The fluid supply chamber 204 includes a reservoir to contain a supply of fluid to be ejected from printhead 200, e.g., to be ejected through the ejector 101. The reservoir of the fluid supply chamber 204 supplies fluid to the pumping chamber 102. The fluid return chamber 206 includes a reservoir to contain fluid recirculated through the printhead 200 through the second fluid flow pathway 116 described with respect to FIG. 1.

The interposer assembly 214 is attachable to the casing 202, such as by bonding or another mechanism of attachment. The interposer assembly 214 includes, for example, an upper interposer 216 and a lower interposer 218. The lower interposer 218 is positioned between the upper interposer 216 and the substrate 300.

A flow pathway 226 is formed to connect, e.g., fluidically connect, the fluid supply chamber 204 to the fluid return chamber 206. The upper interposer 216 includes an inlet 330 to the flow pathway 226 and an outlet 332 from the flow pathway 226. The inlet 330 and the outlet 332, for example, are formed as apertures in the upper interposer 216. The flow pathway 226 is, for example, formed in the upper interposer 216, the lower interposer 218, and the substrate 300. The flow pathway 226 enables flow of fluid from the supply chamber 204, through the substrate 300, into the inlet 330, and to the fluid ejector 101 for ejection of fluid from the printhead 200. The actuator 118 of the ejector 101, when driven, ejects fluid from the pumping chamber 102 through the nozzle 114. The flow pathway 226 also enables flow of fluid from the fluid ejector 101, into the outlet 332, and into the return chamber 206. While FIG. 2 depicts the flow pathway 226 as a single flow pathway forming a straight passage, in some implementations, the printhead 200 includes multiple flow pathways. Alternatively or additionally, one or more of the flows pathways are not straight. In the flow pathway 226, a substrate inlet 310 receives fluid from the supply chamber 204 through the inlet 330. The substrate inlet 310 extends through the substrate 300, in particular, through the membrane 303, and supplies fluid to one or more inlet feed channels 304, which supplies fluid to the fluid ejector 101 through an inlet.

As described with respect to FIG. 1, the fluid ejector 101 includes the nozzle 114. Fluid is selectively ejected from the nozzle 114 of the fluid ejector 101. The fluid is, for example, ink that is ejected onto a surface to print an image on the surface. The nozzle 114 is formed in a nozzle layer 312 of the substrate 300, e.g., on a bottom surface of the substrate 300. In some examples, the nozzle layer 312 is an integral part of the substrate 300. In some examples, the nozzle layer 312 is a layer that is deposited onto the surface of the substrate 300.

Fluid flows through the fluid ejector 101 along an ejector flow pathway 400, e.g., an ejector flow pathway 400 of the ejector 101. The ejector flow pathway 400 further includes multiple flow pathways to transport fluid from reservoirs to eject the fluid and/or to recirculate the fluid to be ejected during a subsequent ejection operation. The ejector flow pathway 400 includes, for example, one or more ejector inlets, one or more recirculation outlets, and one or more nozzles.

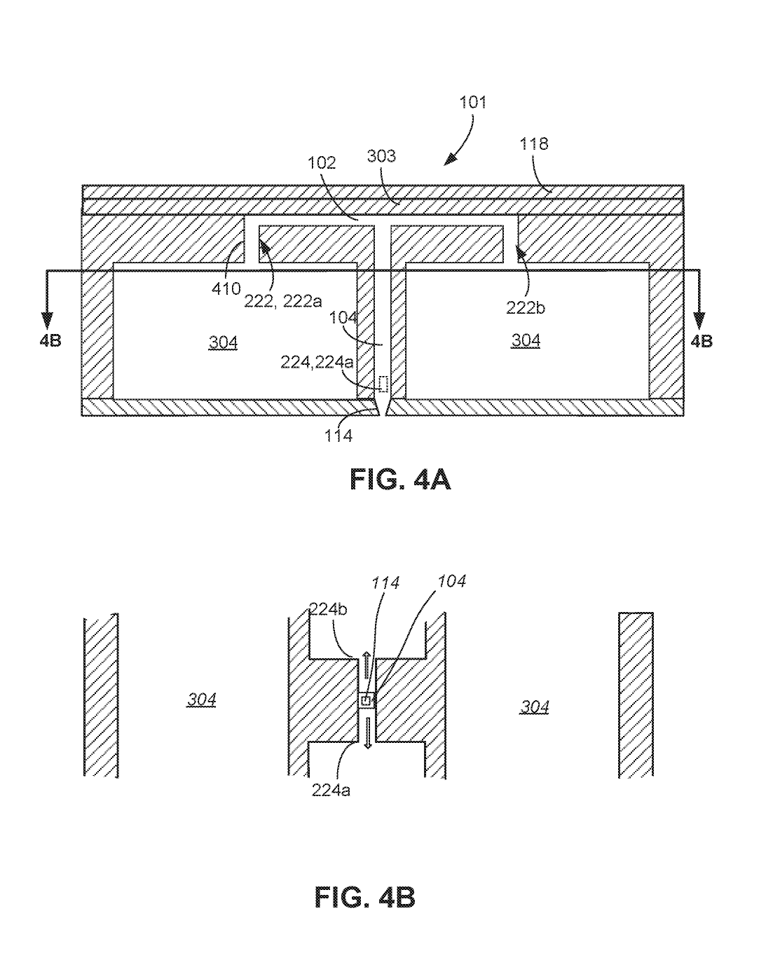

As shown in FIGS. 1, 4A, and 4B, the descender 104 is centered relative to the pumping chamber 102. The first end 106 of the descender 104 is, for example, positioned proximate a center 110 of the pumping chamber 102, such as a geometric centroid of a perimeter of the pumping chamber 102. Alternatively or additionally, the pumping chamber 102 is symmetric about a longitudinal axis 122 extending through the first end 106 and the second end 108 of the descender 104.

In one example, to be ejected from the printhead 200, a portion of fluid flows through an inlet 222 of the fluid ejector 101, through the pumping chamber 102, through the first end 106 of the descender 104, through the descender 104, through the fluid ejector 101, and out of the printhead 200 through the nozzle 114. To be recirculated, a portion of fluid flows through the inlet 222, through the pumping chamber 102, through the first end 106 of the descender 104, through the descender 104, and through an outlet 224 of the fluid ejector 101. The inlet 222 is, for example, an inlet to the pumping chamber 102. The outlet 224 is, for example, an outlet from the descender 104.

The inlet 222 is, for example, connected to a reservoir to enable fluid flow from the reservoir, e.g., the supply chamber 204, to the ejector flow pathway 400 during an ejection operation. An inlet feed channel 304 connects the supply chamber 204 to the inlet 222 of the fluid ejector 101. The inlet 222 includes a first end connected to the supply chamber 204 through the inlet fluid channel 304 and a second end connected to the pumping chamber 102.

The inlet 222 includes, in some examples, an ascender 410, which is connected to the inlet feed channel 304. The ascender 410 is also connected to the pumping chamber 102. The pumping chamber 102 is connected to the descender 104, which is connected to the nozzle 114.

The descender 104 includes the outlet 224. The first fluid flow pathway 112 is, in some cases, perpendicular to an inlet flow pathway 124 through the inlet 222 to the pumping chamber 102. In particular, the longitudinal axis 122 of the descender 104 is perpendicular a flow direction of fluid flowing through the inlet flow pathway 124.

The descender 104 is connected to an outlet feed channel 322 through the outlet 224. The outlet 224 is, for example, connected to another reservoir to facilitate a recirculation fluid flow into the other reservoir, e.g., a reservoir of the return chamber 206, from the ejector flow pathway 400 during the ejection operation. The outlet feed channel 322 connects the outlet 224 to the return chamber 206. In this regard, the outlet 224 includes a first end connected to the descender 104 and a second end, e.g., the outlet feed channel 322, connected to the return chamber 206. In some cases, one or more other fluid channels connect the outlet feed channel 322 to the return chamber 206. In some examples, a substrate outlet (not shown) connects the outlet feed channel 322 to the return chamber 206. In some implementations, the second fluid flow pathway 116 through the outlet 224 is perpendicular to the first fluid flow pathway 112 defined by the descender 104. The outlet 224 forms at least a part of the second fluid flow pathway 116.

In some implementations, the actuator 118 is a piezoelectric actuator including first and second electrodes. The piezoelectric layer 314 is positioned between the first and second electrodes. The first electrode is, for example, a drive electrode 316, and the second electrode is, for example, a ground electrode 318. The drive electrode 316 and the ground electrode 318 are, for example, formed from a conductive material (e.g., a metal), such as copper, gold, tungsten, indium-tin-oxide (ITO), titanium, platinum, or a combination of conductive materials. The thickness of the drive electrode 316 and the ground electrode 318 is, e.g., about 2 μm or less, about 1 μm, about 0.5 μm, etc.

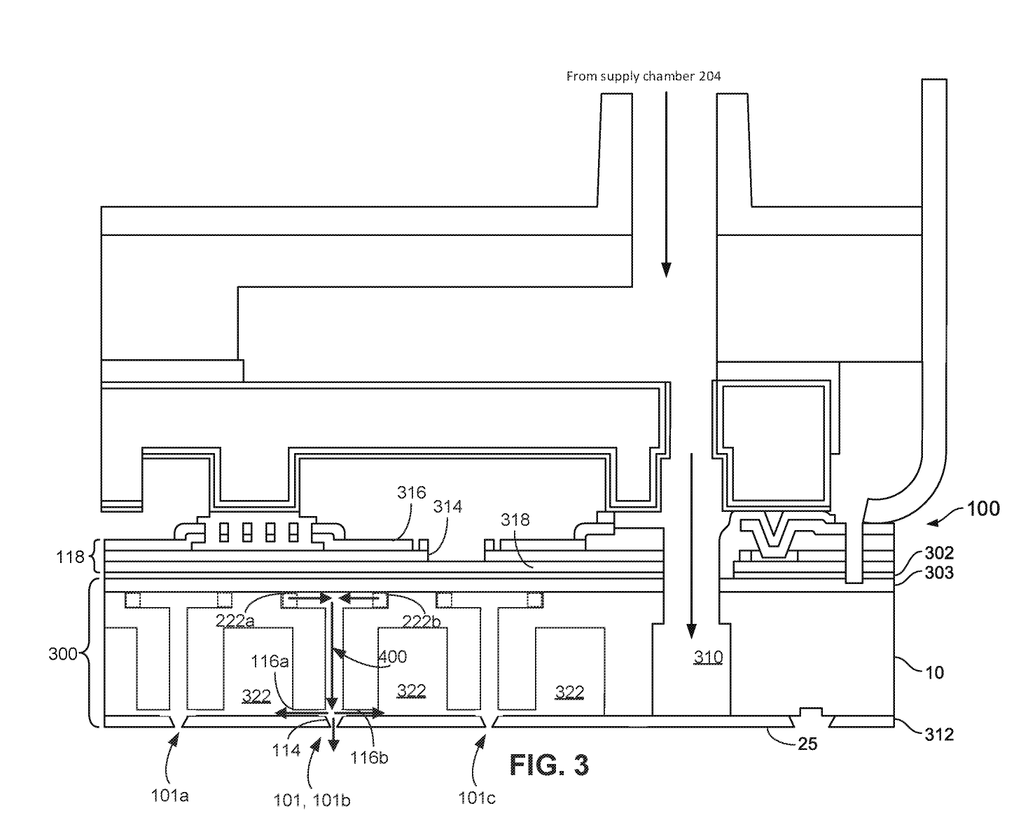

The membrane 303 is positioned between the actuator 118 and the pumping chamber 102, thereby isolating the ground electrode 318 from fluid in the pumping chamber 102. In some examples, the membrane 303 is a layer separate from the substrate 300. In some examples, the membrane 303 is unitary with the substrate 300. While FIG. 3 depicts the ground electrode 318 positioned between the membrane 303 and the piezoelectric layer 314, in some implementations, the drive electrode 316 is positioned between the membrane 303 and the piezoelectric layer 314.

To actuate the piezoelectric actuator 118, an electrical voltage can be applied between the drive electrode 316 and the ground electrode 318 to apply a voltage to the piezoelectric layer 314. The applied voltage induces a polarity on the piezoelectric actuator that causes the piezoelectric layer 314 to deflect, which in turn deforms the membrane 303. The deflection of the membrane 303 causes a change in volume of the pumping chamber 102, producing a pressure pulse in the pumping chamber 102. In the configurations of the fluid ejector 101 described herein, for a given value for the change in volume of the pumping chamber 102 when the piezoelectric actuator 118 is actuated, the resonance frequency can be higher, thereby enabling the actuator 118 to be more rapidly actuated to eject fluid. In particular, a firing frequency of the actuator 118 can be higher.

The printhead 200, in some implementations, includes a controller to apply a voltage to the drive electrode 316 to deform the membrane 303. The controller, for example, operates a drive, e.g., a controllable voltage source to modulate a voltage applied to the drive electrode 316. The applied voltage causes the membrane 303 to deform by a selectable amount. In some implementations, the voltage is applied to the drive electrode 316 in a manner such that the membrane 303 deforms away from the pumping chamber 102. The voltage applied, for example, results in a voltage differential, e.g., a polarity, between the ground electrode 318 and the drive electrode 316 that deflects the piezoelectric layer 314 toward the drive electrode 316. In this regard, if the ground electrode 318 is positioned between the membrane 303 and the piezoelectric layer 314, the membrane 303 deforms away from the pumping chamber 102.

In some implementations, the membrane 303 is formed of a single layer of silicon, e.g., single crystalline silicon. In some implementations, the membrane 303 is formed of another semiconductor material, one or more layers of oxide, such as aluminum oxide (AlO2) or zirconium oxide (ZrO2), glass, aluminum nitride, silicon carbide, other ceramics or metals, silicon-on-insulator, or other materials. The membrane 303 is, for example, formed of an inert material having a compliance such that the membrane 303 flexes sufficiently to eject a drop of fluid when the actuator 118 is driven. In some examples, the membrane 303 is secured to the actuator 118 with an adhesive portion 302. In some examples, two or more of the substrate 300, the nozzle layer 312, and the membrane 303 are formed as a unitary body.

As described herein, the ejector flow pathway 400 can be configured to have a higher resonance frequency, thereby enabling a higher maximum rate of pumping. In particular, the actuator 118 can be actuated rapidly when the resonance frequency is higher, thereby enabling a greater number of drops of fluid to be ejected from the fluid ejector 101 over a given period of time. An overall resonance frequency of the ejector flow pathway 400 can be increased by decreasing a transit time for the pressure pulse generated by the actuator 118 when the actuator 118 is actuated. The transit time through each pathway, in some cases, depends on a length of a pathway between the supply chamber 204 and the fluid ejector 101, a length of a pathway between the fluid ejector and the return chamber 206, a length of a pathway within the fluid ejector 101 to transport fluid from the one or more inlets to the nozzle 114 of the fluid ejector 101, etc. To increase the resonance frequency, a travel time of the pressure pulse through one or more of the segments of the ejector flow pathway 400 can be decreased, e.g., by decreasing a length of the segment. In one example, the transit time can be decreased by decreasing a travel length between the inlet 222 and the nozzle 114 while the change in volume of the pumping chamber 102 with each firing of the piezoelectric actuator 118 is maintained.

The descender 104 being centered can reduce the transit length for the pressure pulse. As described herein, in some examples, multiple inlets into the pumping chamber 102 can ensure that the change in volume of the pumping chamber 102 is maintained at the same level. To maintain the change in volume of the pumping chamber 102 with each firing of the piezoelectric actuator 118, the segments can be arranged to direct flow in parallel to one another. For example, two segments direct fluid in parallel to one another in the ejector flow pathway 400 when the two segments transport separate flows of fluid that are combined to form a single fluid flow along the ejector flow pathway 400.

When the stiffness of the ejector flow pathway 400 increases, the resonance frequency may increase, but a greater voltage may be necessary to achieve the same amount of deflection of the actuator 118. In this regard, the actuator 118 can operate less efficiently, e.g., have a lower ejection volume per applied volt, when the resonance frequency is increased through stiffer components. The resonance frequency can be increased without increasing the amount of voltage applied to eject a given volume of fluid. In particular, the resonance frequency can be increased by decreasing the travel time of a pressure pulse generated by the actuator 118 through the fluid flow pathway 400.

In one example of decreasing the travel time of a pressure pulse while maintaining the change in volume associated with the pressure pulse, the fluid ejector 101 includes multiple inlets into the fluid ejector 101, e.g., multiple inlets from one or more reservoirs into the pumping chamber 102. Each of the inlets supplies fluid to the pumping chamber 102. Each of the inlets, in this regard, form a separate fluid pathway that runs in parallel to the fluid pathways formed by the other inlets. The fluid pathways recombine into a single flow at or near the descender 104. The recombined flow then travels through the descender 104. In some cases, the inlets are positioned to direct fluid toward the center 110 of the pumping chamber 102. An axis of flow into the pumping chamber 102 for each inlet intersects the center of the pumping chamber 102. The descender 104 is positioned within a perimeter of the pumping chamber 102 and between the inlets. The descender 104 is, for example, equidistant to each of the inlets.

In a specific example, the inlet 222 is a first inlet 222a into the pumping chamber 102, and the ejector flow pathway 400 includes a second inlet 222b into the pumping chamber 102. The first inlet 222a and the second inlet 222b are, in some cases, equidistant to the first end 106 of the descender 104. The width of the descender 104 is, for example, 10% to 90% a distance between the first inlet 222a and the second inlet 222b.

The first inlet 222a and the second inlet 222b direct fluid along parallel fluid pathways. Referring back to FIG. 1, the first inlet 222a defines a first inlet pathway 124a, and the second inlet 222b defines a second inlet pathway 124b. The first inlet pathway 124a and the second inlet pathway 124b are parallel fluid pathways. In some implementations, the first inlet 222a and the second inlet 222b are positioned to direct fluid into the pumping chamber 102 in opposite directions, e.g., fluid flows along the inlet pathway 124a in a direction opposite a direction of fluid flowing along the inlet pathway 124b. The inlet pathway 124a and the inlet pathway 124b recombine in the pumping chamber 102 and enter the descender 104 through the first end 106 as a combined flow. The descender 104 is positioned such that fluid from a distance that fluid travels from the inlet 222a to the descender 104 is equal to distance that the fluid travels from the inlet 222b to the descender 104.

The first inlet 222a is, for example, connected to a first reservoir, and the second inlet 222b is, for example, connected to a second reservoir. In this regard, the ejector flow pathway 400 receives fluid from multiple fluid reservoirs. If the ejector flow pathway 400 receives fluid from multiple fluid reservoirs, the printhead 200 is, for example, connected to multiple supply chambers, e.g., the supply chamber 204. In some cases, the first inlet 222a and the second inlet 222b receive fluid from the same reservoir. While the ejector flow pathway 400 receives fluid from a single reservoir in such cases, the ejector flow pathway 400 includes multiple ingress flows from the single reservoir. The reservoir is, for example, a reservoir of the supply chamber 204.

The combined flow travels through the descender 104, and, if the ejector flow pathway 400 includes pathways to recirculate the fluid to be used in a subsequent ejection operation, a first portion of the combined flow is ejected through the nozzle 114, and a second portion of the combined flow from the descender 104 is transported through the outlet 224. The descender 104 receives the combined flow from the pumping chamber 102 and is configured to transport the first portion of the combined flow to the nozzle 114 and the second portion of the combined flow through the outlet 224. The second portion corresponds to, for example, fluid that is not ejected through the nozzle 114 during the ejection operation and is, instead, recirculated for ejection during a subsequent ejection operation. In one example, the ejector flow pathway 400 bifurcates at the descender 104, e.g., near the second end 108 of the descender 104, into a pathway for fluid to be recirculated and into another pathway for fluid to be ejected from the printhead 200. The fluid to be recirculated exits descender 104 through the outlet 224, and the fluid to be ejected from the printhead 200 exits through the nozzle 114 of the fluid ejector 101.

In one example, referring back to FIG. 1, the second fluid flow pathway 116 is one of multiple recirculation fluid flow pathways. The second fluid flow pathway 116 is a first recirculation pathway 116a, and the ejector 101 includes a second recirculation pathway 116b. The first outlet 224a, for example, forms the first fluid flow pathway 116a, and the second outlet 224b forms the second fluid flow pathway 116b. The descender 104 divides into multiple pathways such that both the first and second fluid flow pathways 116a, 116b are formed in addition to the pathway through the nozzle 114.

Each of the multiple recirculation pathways 116a, 116b are connected to one or more reservoirs, e.g., of one or more return chambers. In the example shown in FIGS. 4A and 4B, the first outlet 224a is connected to a first reservoir, and the second outlet 224b is connected to a second reservoir. In this regard, the ejector flow pathway 400 transports fluid to be recirculated to multiple reservoirs. If the ejector flow pathway 400 transports fluid to multiple reservoirs, the printhead 200 is, for example, connected to multiple return chambers, e.g., the return chamber 206. In some cases, the first outlet 224a and the second outlet 224b transport fluid to the same reservoir. While the ejector flow pathway 400 transports fluid to be recirculated to a single reservoir in such cases, the ejector flow pathway 400 includes multiple egress flows into this single reservoir. The reservoir is, for example, a reservoir of the return chamber 206.

A number of implementations have been described. Nevertheless, various modifications are present in other implementations.

While the example shown in FIGS. 3 and 4A depict flow pathways, such as the substrate inlet 310 and the outlet feed channel 322, in a common plane, in some examples, in some implementations, the substrate inlet 310 and the outlet feed channel 322 are not in a common plane. The inlet feed channel 304 and the substrate inlet 310, in some cases, are in common plane. Alternatively, the substrate inlet 310, the outlet feed channel 322, and the inlet feed channel 304 are all in a common plane. While the first inlet pathway 124a and the second inlet flow pathway 124b are shown in FIG. 1 as being in a common plane, in some cases, the inlet flow pathway 124a and the inlet flow pathway 124b are not in common planes. The inlet flow pathways 124a, 124b are, for example, within planes angled relative to one another, e.g., perpendicular to one another. Similarly, while the first recirculation pathway 116a and the second recirculation pathway 116b are shown as being in a common plane, in some cases, the first recirculation pathway 116a and the second recirculation pathway 116b are not in common planes. In some implementations, one or more of the recirculation pathways 116a, 116b and one or more of the inlet flow pathways 124a, 124b are not in common planes.

While the fluid ejector 101 has been described as a single fluid ejector, a fluid delivery system in some implementations includes multiple fluid ejectors. Referring back to FIG. 3, the fluid ejector 101 is, for example, one of many fluid ejectors, e.g., the fluid ejector 101a and the fluid ejector 101b.The fluid ejectors 101a, 101b each include an ejector flow pathway similar to the ejector flow pathway 400 described with respect to the fluid ejector 101b. In this regard, the fluid ejectors 101a, 101b also include corresponding inlets, pumping chambers, descenders, outlets, and actuators to drive fluid through their ejector flow pathways.

The printhead 200 includes, for example, multiple inlet feed channels extending parallel with one another. Each inlet feed channel is in fluidic communication with a substrate inlet that extends from the inlet feed channel. Multiple outlet feed channels are formed in the substrate 300 and, in some cases, extend parallel with one another. Each outlet feed channel is in fluidic communication with at least one substrate outlet that extends from one of the outlet feed channels. In some examples, the inlet feed channels and the outlet feed channel are arranged in alternating rows.

In some implementations, the fluid ejectors are arranged in an array. The fluid ejectors in a given column of the array can be connected to the same inlet feed channel and to the same outlet feed channel. Fluid ejectors of different columns of the array can be connected to different inlet feed channels and to different outlet feed channels. In some examples, fluid ejectors in adjacent columns can all be connected to the same inlet feed channel or the same outlet feed channel, but not both.

If the fluid ejectors 101a, 101b, 101c include multiple inlets, in some cases, all of the first inlets of the fluid ejectors 101a, 101b, 101c are connected to a reservoir of a first supply chamber, and all of the second inlets of the fluid ejectors 101a, 101b, 101c are connected to a reservoir of a second supply chamber. In some cases, all inlets of the fluid ejectors 101a, 101b, 101c are connected to the same reservoir. If the fluid ejectors 101a, 101b, 101c include multiple outlets, in some cases, all of the first outlets of the fluid ejectors 101a, 101b, 101c are connected to a reservoir of a first return chamber, and all of the second outlets of the fluid ejectors 101a, 101b, 101c are connected to a reservoir of a second return chamber. In some implementations, the inlets of the fluid ejectors 101a, 101b, 101c adjacent to one another are connected to the same reservoir, e.g., a second inlet of the fluid ejector 101a and a first inlet of the fluid ejector 101b are connected to same reservoir. Similarly, in some implementations, the outlets of the fluid ejectors 101a, 101b, 101c adjacent to one another are connected to the same reservoir, e.g., a second outlet of the fluid ejector 101a and a first outlet of the fluid ejector 101b are connected to same reservoir.

The actuators described herein are, in some implementations, unimorphs. In this regard, an actuator in such implementations includes a single active layer and a single inactive layer. The actuator 118, for example, includes the membrane 303. In this regard, the piezoelectric layer 314 corresponds to the active layer, and the membrane 303, e.g., the membrane 303, corresponds to the inactive layer.

In one specific example, a printhead has a feed channel (e.g., an inlet feed channel 304 or an outlet feed channel 322) that serves 16 fluid ejectors (hence there are 16 menisci associated with the feed channel). The feed channel has a width of 0.39 mm, a depth of 0.27 mm, and a length of 6 mm. The thickness of the silicon nozzle layer 312 is 30 μm. The radius of each meniscus is between 5 and 30 μm. A typical bulk modulus for a water-based inks is about B=2E9 Pa and a typical surface tension is about 0.035 N/m.

While the fluid ejector 101 has been described as including both the actuator 118 and the membrane 303, in some examples, the fluid ejector 101 does not include a membrane 303. The ground electrode 318 is, for example, formed on the back side of the piezoelectric layer 314 such that the piezoelectric layer 314 is directly exposed to fluid in the pumping chamber 102. If the actuator 118 includes one or more trenches as described herein, the one or more trenches extend partially through the piezoelectric layer 314, e.g., 50% to 95% through a depth of the piezoelectric layer 314.

Accordingly, other implementations are within the scope of the claims.

What is claimed is:

1. An apparatus comprising:
a pumping chamber;
a descender having a first end and a second end, the first end of the descender centered relative to the pumping chamber and defining a first fluid flow pathway between the pumping chamber and a nozzle disposed at the second end of the descender,
wherein one or more second fluid flow pathways are defined at the second end of the descender.

2. The apparatus of claim 1, further comprising a piezoelectric actuator operable to pump fluid through the pumping chamber toward the nozzle.

3. The apparatus of claim 1, wherein the pumping chamber comprises a first inlet to receive fluid from a reservoir.

4. The apparatus of claim 3, wherein the pumping chamber comprises a second inlet to receive fluid from the reservoir.

5. The apparatus of claim 4, wherein a width of the descender is 10% to 90% a distance between the first inlet and the second inlet.

6. The apparatus of claim 4, wherein the first inlet and the second inlet are equidistant to the first end of the descender.

7. The apparatus of claim 4, wherein the first inlet is configured to be connected to a first reservoir and the second inlet is configured to be connected to a second reservoir.

8. The apparatus of claim 1, wherein the pumping chamber is symmetric about a longitudinal axis extending through the first end and the second end of the descender.

9. The apparatus of claim 1, wherein the nozzle is configured such that a first portion of fluid flow from the pumping chamber through the descender is ejected through the nozzle, and the one or more second fluid flow pathways are configured to receive a second portion of fluid flow that is not ejected through the nozzle.

10. The apparatus of claim 7, wherein:
the one or more second fluid flow pathways comprises a plurality of fluid flow pathways to receive a portion of fluid flow from the pumping chamber through the descender, a first of the fluid flow pathways to be connected to the first reservoir, and a second of the fluid flow pathways to be connected to the second reservoir, and
the portion of the fluid flow is not ejected through the nozzle.

11. The apparatus of claim 1, wherein the one or more second fluid flow pathways is a recirculation fluid flow pathway.

12. The apparatus of claim 11, wherein the recirculation fluid flow pathway comprises a first end proximate to the second end of the descender and a second end configured to be connected to a reservoir.

13. An system comprising:
a reservoir
a pumping chamber comprising an inlet to receive fluid from the reservoir;
a descender having a first end and a second end, the first end of the descender centered relative to the pumping chamber and defining a first fluid flow pathway between the pumping chamber and a nozzle disposed at the second end of the descender,
wherein one or more second fluid flow pathways are defined at the second end of the descender.

14. The system of claim 13, wherein the pumping chamber is symmetric about a longitudinal axis extending through the first end and the second end of the descender.

15. The system of claim 13, further comprising a piezoelectric actuator operable to pump fluid through the pumping chamber toward the nozzle.

16. The system of claim 13, wherein the inlet is a first inlet, and the pumping chamber comprises a second inlet to receive fluid from the reservoir.

17. The system of claim 16, wherein a width of the descender is 10% to 90% a distance between the first inlet and the second inlet.

18. The system of claim 16, wherein the first inlet and the second inlet are equidistant to the first end of the descender.

19. The system of claim 16, wherein the first inlet is configured to be connected to a first reservoir and the second inlet is configured to be connected to a second reservoir.

20. The system of claim 13, wherein the nozzle is configured such that a first portion of fluid flow from the pumping chamber through the descender is ejected through the nozzle, and the one or more second fluid flow pathways are configured to receive a second portion of fluid flow that is not ejected through the nozzle.

21. The system of claim 19, wherein:
the one or more second fluid flow pathways comprises a plurality of fluid flow pathways to receive a portion of fluid flow from the pumping chamber through the descender, a first of the fluid flow pathways to be connected to the first reservoir, and a second of the fluid flow pathways to be connected to the second reservoir, and
the portion of the fluid flow is not ejected through the nozzle.

22. The system of claim 13, wherein the one or more second fluid flow pathways is a recirculation fluid flow pathway.

23. The system of claim 22, wherein the recirculation fluid flow pathway comprises a first end proximate to the second end of the descender and a second end configured to be connected to a reservoir.
